(19) United States
(12) Patent Application Publication
(10) Pub. No.: US 2014/0258879 A1
(43) Pub. Date: Sep. 11, 2014

(54) THEME ENGINE

(71) Applicant: INTERNATIONAL BUSINESS MACHINES CORPORATION, Armonk, NY (US)

(72) Inventors: Lisa Seacat DeLuca, San Francisco, CA (US); Jennifer Elizabeth King, Austin, TX (US); Fabian F. Morgan, Austin, TX (US)

(73) Assignee: INTERNATIONAL BUSINESS MACHINES CORPORATION, Armonk, NY (US)

(21) Appl. No.: 13/791,795

(22) Filed: Mar. 8, 2013

(51) Int. Cl. H04L 29/08

(52) U.S. Cl. CPC H04L 67/18
USPC 715/744

(57) ABSTRACT

A method includes activating a theme engine, determining a proximity between a user's device and at least one known person, and applying at least one theme to the user's device based on the proximity between the user's device and the at least one known person.

### BACKGROUND

The present invention relates to changing themes for user devices, and more specifically, to changing user device themes based upon the proximity to other known users.

### SUMMARY

According to one aspect of the present invention, a method includes activating a theme engine, determining a proximity between a user's device and at least one known person, and applying at least one theme to the user's device based on the proximity between the user's device and the at least one known person.

According to another aspect of the present invention, a computer system comprising, one or more processors, one or more computer-readable memories and one or more computer-readable, tangible storage devices, a theme engine module operatively coupled to at least one of the one or more storage devices for execution by at least one of the one or more processors via at least one of the one or more memories, configured to provide themes, a proximity module operatively coupled to at least one of the one or more storage devices for execution by at least one of the one or more processors via at least one of the one or more memories, configured to determine proximity between a user's device and at least one known person; and an applying module operatively coupled to at least one of the one or more storage devices for execution by at least one of the one or more processors via at least one of the one or more memories, configured to apply at least one theme to the user's device based on the proximity between the user's device and the at least one known person.

According to still another aspect of the present invention, a computer program product including one or more computer-readable, tangible storage medium, program instructions, stored on at least one of the one or more storage medium, to activate a theme engine, program instructions, stored on at least one of the one or more storage medium, to determine a proximity between a user's device and at least one known person, and program instructions, stored on at least one of the one or more storage medium, to apply at least one theme to the user's device based on the proximity between the user's device and the at least one known person.

### BRIEF DESCRIPTION OF THE SEVERAL VIEWS OF THE DRAWINGS

FIG. 1 illustrates a process for applying themes to user devices according to an embodiment of the present invention.

FIG. 2 depicts an exemplary implementation according to an embodiment of the present invention.

FIG. 3 depicts another exemplary implementation according to an embodiment of the present invention.

FIG. 4 depicts still another exemplary implementation according to an embodiment of the present invention.

FIG. 5 illustrates a hardware configuration according to an embodiment of the present invention.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting. As will be appreciated by one skilled in the art, aspects of the present invention may be embodied as a system, method or computer program product.

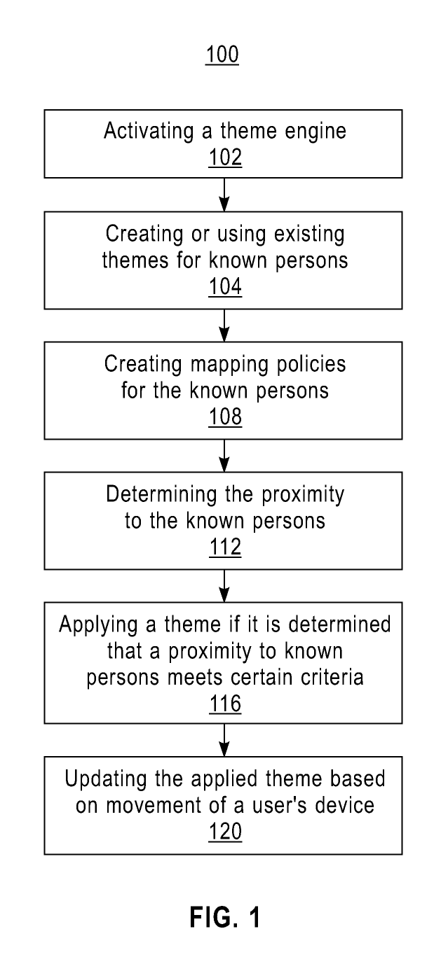

With reference now to FIG. 1, shown is a process (100) for applying themes to a user's device based on the proximity to known persons by using a theme engine. The process starts by activating a theme engine (102). The theme engine may reside within the user's device. In other embodiments, the theme engine could be a service that is cloud based or provided by a network provider. Once the theme engine is activated users are allowed to create or use existing themes for known persons (104). The known persons may be contacts listed in an address book, from a social network or from a company directory. Objects that may be affected by the theme changes may include but are not limited to:
1. background graphic
2. arrangement of icons
3. favorites
4. shortcuts on different screens
5. default ringtone
6. default font
7. showing folders
8. showing images
9. widgets
10. unlock patterns/passwords

Still referring to FIG. 1, once the themes are created or used, they are mapped to specific known persons (108). For example, theme 1 can be mapped to known person A. Theme 2 can be mapped to known person B, etc. It is also possible to have a default theme for known people in general and a default theme for unknown people. The process then conducts a search for known persons within a certain proximity (112). Proximity determination can be conducted by using the GPS of the electronic device for a user and electronic devices of the known persons. Settings can be set to determine if the user's device is within 100 feet, 1 mile or even in the same city of a known person(s). Current smart electronic devices such as phones, tablets, and laptop computers have GPS capabilities and routinely broadcast their location. Proximity determination may also be event or calendar based. Still another way for determining the proximity may use either cell or IP network address location. The theme engine can also apply weights to specific themes based on priorities of the known users. One such weight factor can be the degree of friendship within a social network. Another weight factor can be setting higher priority grouping: ex. family>friends>coworkers>acquaintances.

Once it is determined that a known person(s) meets a set proximity criteria, the appropriate mapped theme is applied to the user's device for the known person (116). The theme engine may apply a theme based on the user's device. For example, a theme may be applied depending on the orientation of the user's device. The theme engine may also apply a theme using accelerometer details, ex. pointing towards known user A, use theme A→pointing towards known user B, use theme B. Yet another theme may be mapped and applied based on multiple known persons all meeting the proximity criteria. For example, if known user A and known user B both meet the proximity criteria then the theme engine applies a theme C to the user's device. It should be noted the theme engine repeats the above process depending on the movement of the user's device (120) and/or the movement of the known contact's device and then applies the appropriate theme on the user's device.

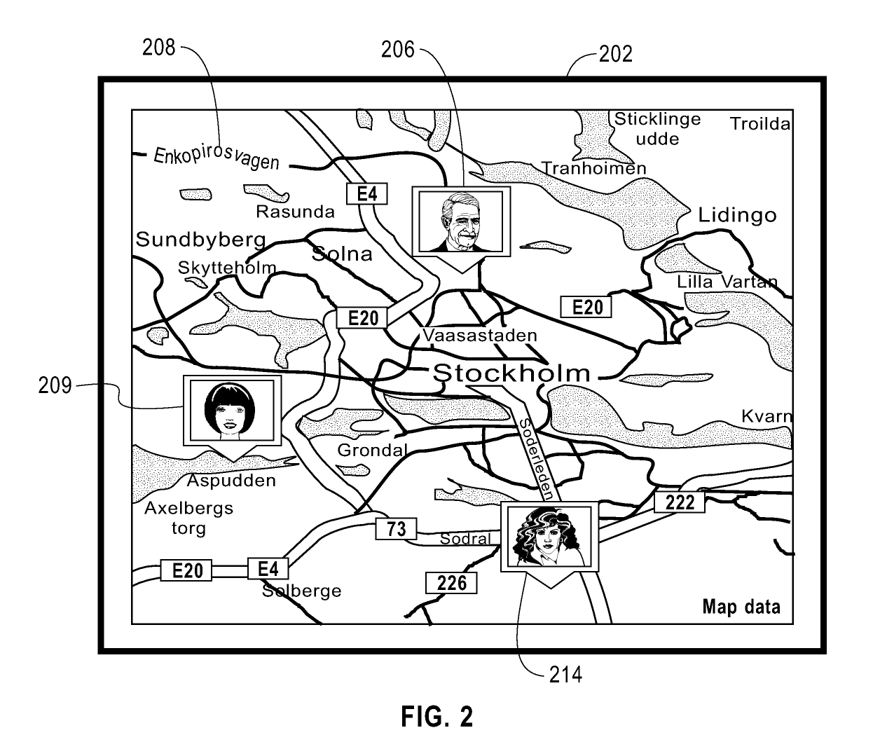

Referring to FIGS. 2, 3 and 4, depicted are three exemplary implementations for the embodiments of the present invention. FIG. 2 depicts a user's device 202. Shown is an implementation of a theme for the user's device where two known users meet the proximity criteria. The user's icon image 206 is placed on a map 208 along with known users' icon images (209, 214). As part of this theme policy, the user 206 has the photos of each of these known persons pulled up as a rotating picture widget on his electronic device. Also, as part of the user's current theme, the known friends can show up as a shortcut links.

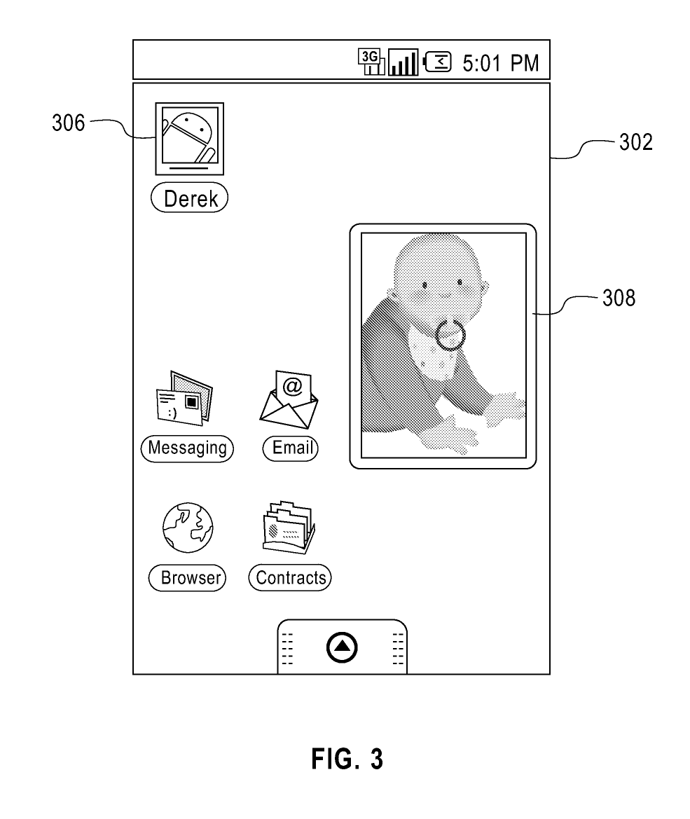

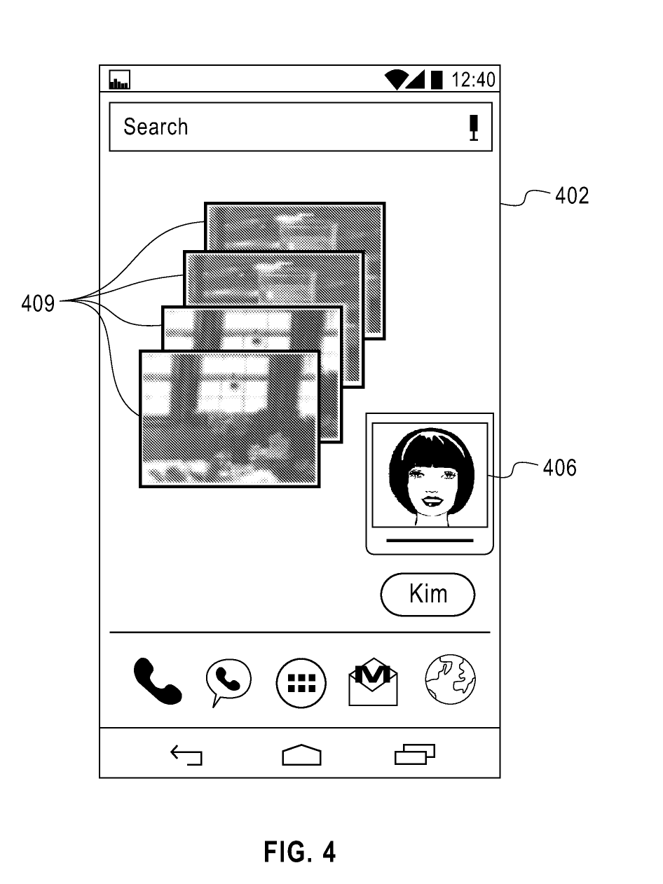

Referring to FIG. 3, the user's device is a smartphone 302. The theme in this exemplary implementation creates a widget that is loaded on the user's smart phone. In the example, pictures 308 of the known user and a shortcut-dialing link 306 are created when the known person meets the proximity criteria. Referring to FIG. 4, the user's device is a smartphone 402. The theme in this exemplary implementation creates a widget that is loaded on the user's smartphone. In the example, pictures 409 associated with a social network of the known person 406 are created when the known person 406 meets the proximity criteria.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

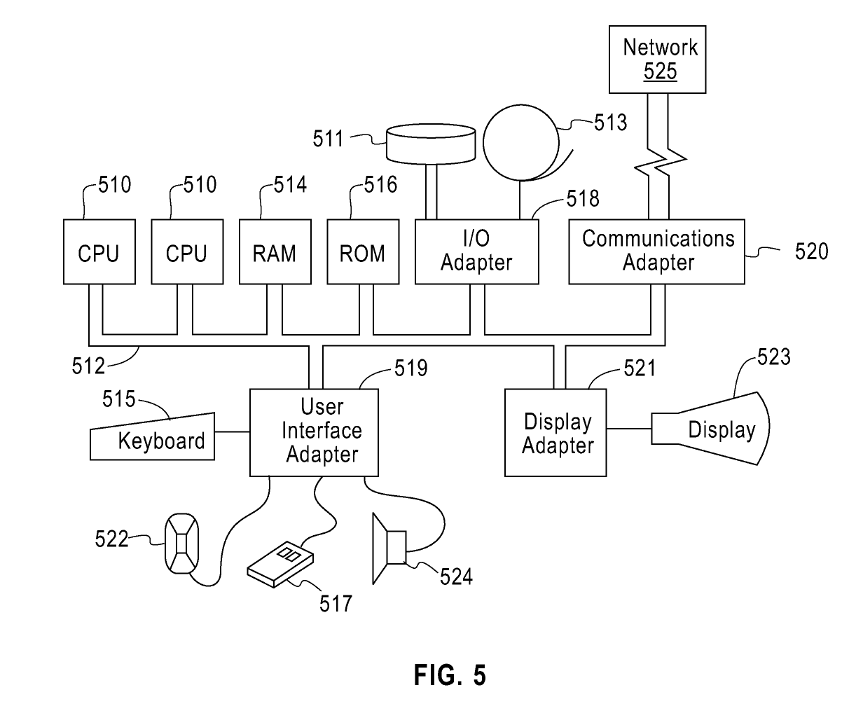

Referring now to FIG. 5, this schematic drawing illustrates a hardware configuration of an information handling/computer system in accordance with the embodiments of the invention. The system comprises at least one processor or central processing unit (CPU) 510. The CPUs 510 are interconnected via system bus 512 to various devices such as a random access memory (RAM) 514, read-only memory (ROM) 516, and an input/output (I/O) adapter 518. The I/O adapter 518 can connect to peripheral devices, such as disk units 511 and tape drives 513, or other program storage devices that are readable by the system. The system can read the inventive instructions on the program storage devices and follow these instructions to execute the methodology of the embodiments of the invention. The system further includes a user interface adapter 519 that connects a keyboard 515, mouse 517, speaker 524, microphone 522, and/or other user interface devices such as a touch screen device (not shown) to the bus 512 to gather user input. Additionally, a communication adapter 520 connects the bus 512 to a data processing network 525, and a display adapter 521 connects the bus 512 to a display device 523 which may be embodied as an output device such as a monitor, printer, or transmitter, for example.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
activating a theme engine;
determining a proximity between a user's device and at least one known person; and
applying at least one theme to the user's device based on the proximity between the user's device and the at least one known person.

2. The method according to claim 1, further comprises creating mapping policies between the at least one known person and the at least one theme.

3. The method according to claim 1, further comprises modifying said at least one theme depending on a priority of said at least one known person.

4. The method according to claim 1, further comprises modifying said at least one theme depending on the number of known persons meeting a proximity criteria.

5. The method according to claim 2, wherein the mapping includes a theme based on at least two known persons.

6. The method according to claim 4, wherein said modified at least one theme is based upon a change in proximity to said known persons.

7. A computer system comprising:
one or more processors, one or more computer-readable memories and one or more computer-readable, tangible storage devices;
a theme engine module operatively coupled to at least one of the one or more storage devices for execution by at least one of the one or more processors via at least one of the one or more memories, configured to provide themes;
a proximity module operatively coupled to at least one of the one or more storage devices for execution by at least one of the one or more processors via at least one of the one or more memories, configured to determine proximity between a user's device and at least one known person; and
an applying module operatively coupled to at least one of the one or more storage devices for execution by at least one of the one or more processors via at least one of the one or more memories, configured to apply at least one theme to the user's device based on the proximity between the user's device and the at least one known person.

8. The system according to claim 7, further comprises a mapping module operatively coupled to at least one of the one or more storage devices for execution by at least one of the one or more processors via at least one of the one or more memories, configured to create mapping policies between the at least one known person and the at least one theme.

9. The system according to claim 7, further comprises a modification module operatively coupled to at least one of the one or more storage devices for execution by at least one of the one or more processors via at least one of the one or more memories, configured to a modify said at least one theme depending on a priority of said at least one known person.

10. The system according to claim 7, further comprises a modification module operatively coupled to at least one of the one or more storage devices for execution by at least one of the one or more processors via at least one of the one or more memories, configured to a modify said at least one theme depending on the number of known persons meeting a proximity criteria.

11. The system according to claim 8, wherein the mapping policies maps a theme based on at least two known persons.

12. The system according to claim 10 wherein said modified at least one theme is based upon a change in proximity to said known persons.

13. A computer program product comprising:
one or more computer-readable, tangible storage medium;
program instructions, stored on at least one of the one or more storage medium, to activate a theme engine;
program instructions, stored on at least one of the one or more storage medium, to determine a proximity between a user's device and at least one known person; and
program instructions, stored on at least one of the one or more storage medium, to apply at least one theme to the user's device based on the proximity between the user's device and the at least one known person.

14. The computer program product according to claim 13, further includes program instructions, stored on at least one of the one or more storage medium, to create mapping policies between the at least one known person and the at least one theme.

15. The computer program product according to claim 13 further includes program instructions, stored on at least one of the one or more storage medium, to modify said at least one theme depending on a priority of said at least one known person.

16. The computer program product according to claim 13 further includes program instructions, stored on at least one of the one or more storage medium, to modify said at least one theme depending on the number of known persons meeting a proximity criteria.

17. The computer program product according to claim 14 wherein the mapping policies maps a theme based on at least two known persons.

18. The computer program product according to claim 16, wherein said modified at least one theme is based upon a change in proximity to said known persons.
